(19) United States
(12) Patent Application Publication
(10) Pub. No.: US 2026/0300842 A1
(43) Pub. Date: Oct. 1, 2026

(54) Machine Learning Pipeline for Validated Performance

(71) Applicant: Axon Enterprise, Inc., Scottsdale, AZ (US)

(72) Inventors: Leo Dirac, Seattle, WA (US); Tyler Romero, Seattle, WA (US); Brandon Wada, Seattle, WA (US)

(21) Appl. No.: 19/097,052

(22) Filed: Apr. 1, 2025

(51) Int. Cl. G06N 20/20

(52) U.S. Cl. CPC G06N 20/20

(57) ABSTRACT

A machine learning management system may use multiple machine learning systems in parallel to train on the same data and correlate answers. Typically, a lighter-weight classifier may be paired with a higher-cost, more accurate classifier. When a more accurate classifier finds a discrepancy between the classification of a lighter-weight classifier, the discrepancy may be used to re-train the classifiers, thereby increasing the accuracy of the lighter-weight classifier. Once the lighter-weight classifier has achieved a desired level of accuracy, the higher-cost classifier may be used to periodically monitor the lighter-weight classifier. In some cases, a human in the loop may be used to validate the classifiers. Some cases may deploy several layers of classifiers of varying complexities, costs, accuracies, or other differentiators and a machine learning management system may test and refine the classifiers by comparing results between the classifiers to achieve a desired performance metric.

### BACKGROUND

Machine learning systems, especially classification engines, operate in a probabilistic manner, such that every classification is classified not to an absolute match, but to some probability of a match. The probability of a match may vary as inputs vary, and as a model might be retrained.

Further, some classification systems may be inherently more accurate than others. Artificial neural networks with smaller number of nodes may be less accurate than deeper artificial neural networks with more nodes and more layers of nodes. However, for the accuracy of the larger models, a sacrifice may be made in speed, energy cost, hardware complexity, training costs, and the like.

### SUMMARY

A machine learning management system may use multiple machine learning systems in parallel to train on the same data and correlate answers.

Typically, a lighter-weight classifier may be paired with a higher-cost, more accurate classifier. When a more accurate classifier finds a discrepancy between the classification of a lighter-weight classifier, the discrepancy may be used to re-train the classifiers, thereby increasing the accuracy of the lighter-weight classifier. Once the lighter-weight classifier has achieved a desired level of accuracy, the higher-cost classifier may be used to periodically monitor the lighter-weight classifier. In some cases, a human in the loop may be used to validate the classifiers. Some cases may deploy several layers of classifiers of varying complexities, costs, accuracies, or other differentiators and a machine learning management system may test and refine the classifiers by comparing results between the classifiers to achieve a desired performance metric.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

### In the Drawings,

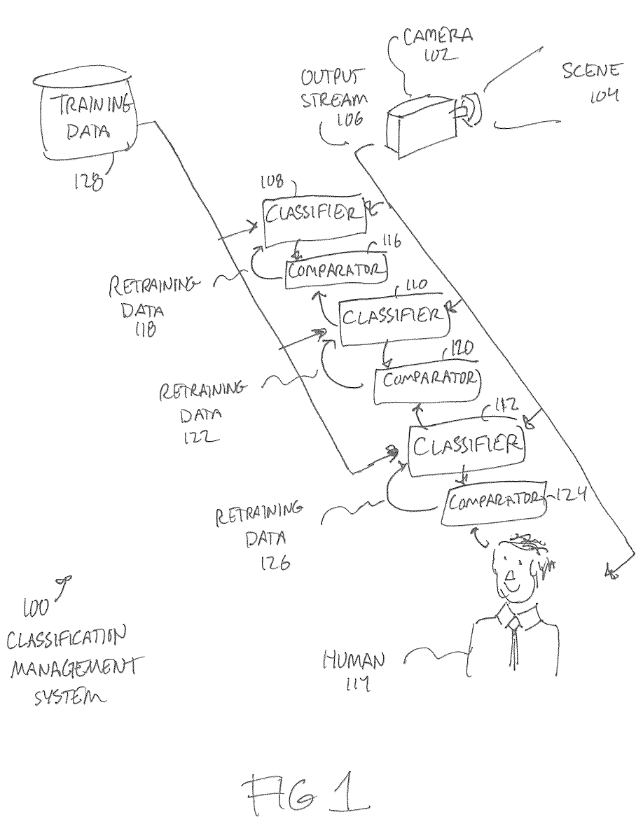

FIG. 1 is a diagram illustration of an example showing a pipeline of classification engines that generate training data.

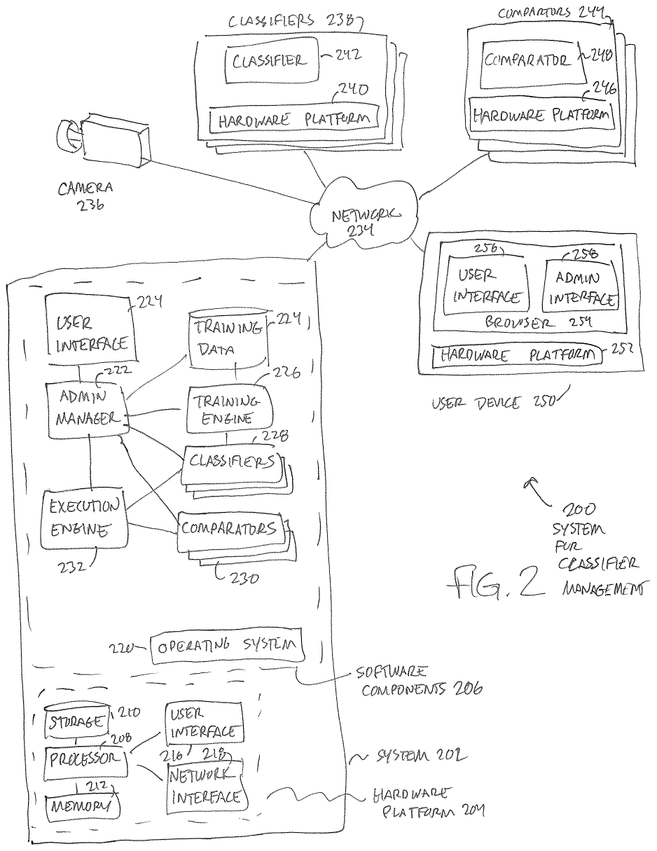

FIG. 2 is a diagram illustration of an example showing a schematic or functional representation of a networked system that links multiple classifiers together.

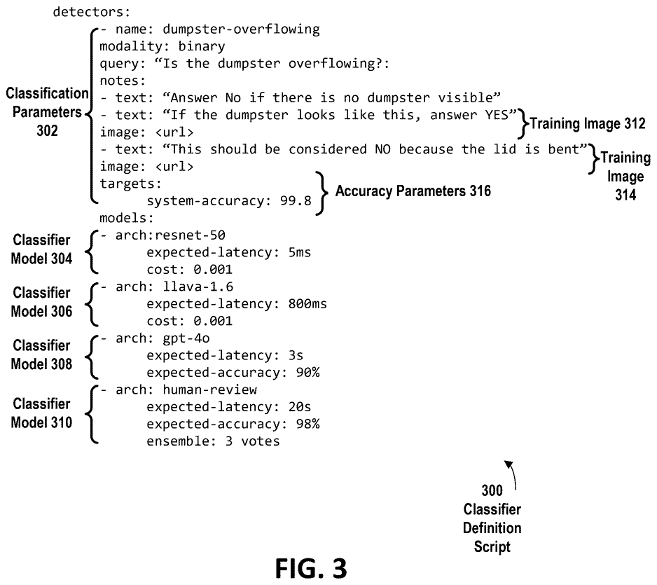

FIG. 3 is a diagram illustration of an example showing a script definition of a sequence of classifiers.

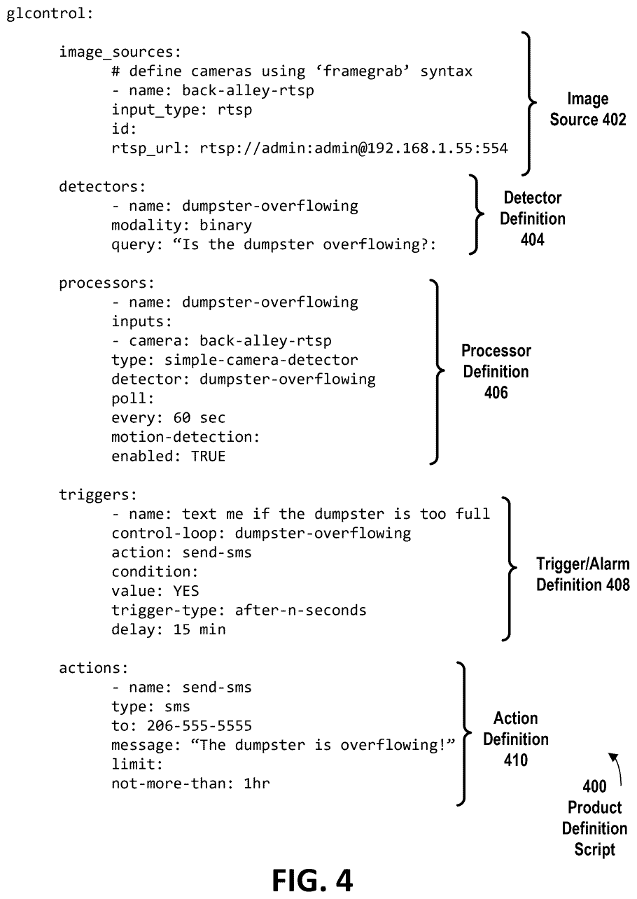

FIG. 4 is a diagram illustration of an example showing a script definition of a classification system.

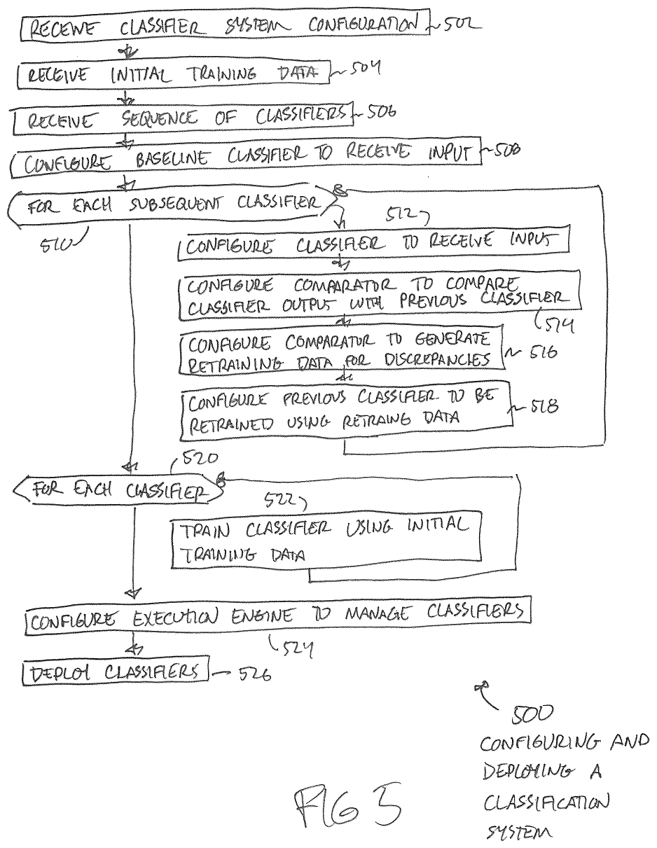

FIG. 5 is a flowchart illustration of an example method showing a sequence for setting up and configuring multiple classifiers together.

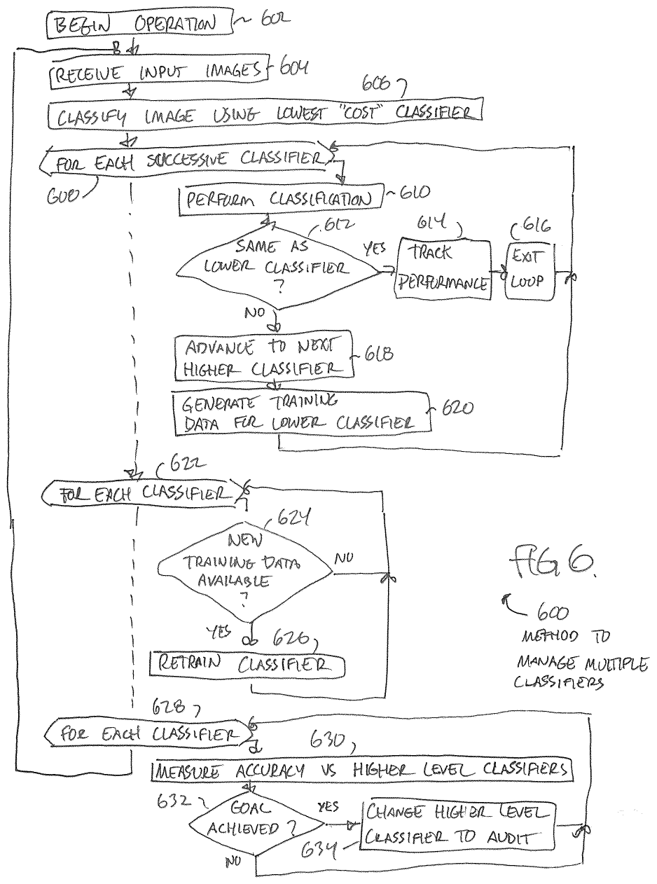

FIG. 6 is a flowchart illustration of an example method showing the operations of a system with multiple classifiers.

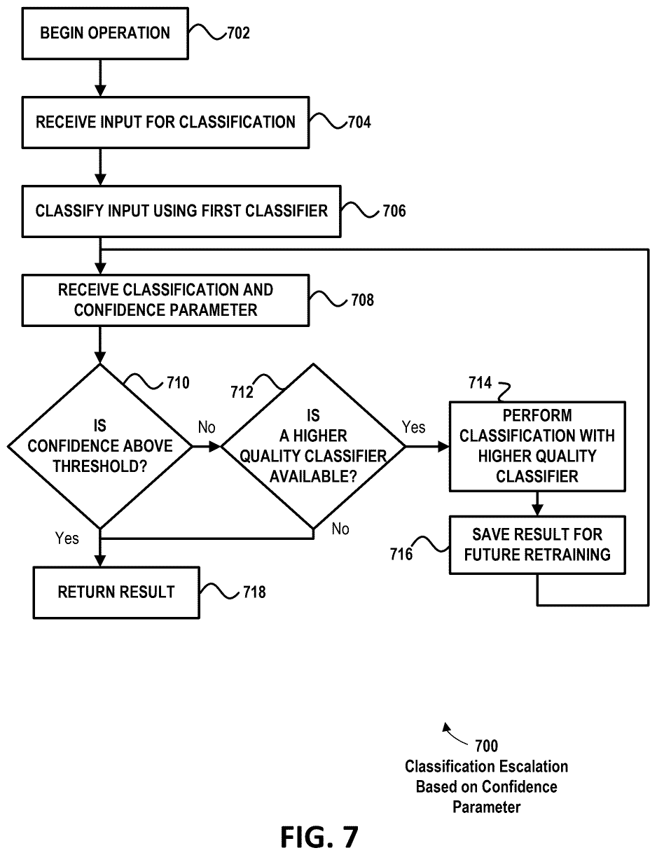

FIG. 7 is a flowchart illustration of an example method showing a classification escalation based on confidence parameters.

### DETAILED DESCRIPTION

### Management of Multiple Machine Learning Systems to Achieve a Performance Target

A machine learning management system may deploy multiple machine classification systems to receive an input stream and compare results. When differences occur between two or more machine classification systems, a set of updated training data may be created and used to re-train at least one of the machine classification systems. Such a system may deploy different machine classification systems, each with different performance characteristics, different training and operational costs, and different accuracies. By comparing ‘better’ systems against ‘poorer’ systems, the ‘poorer’ systems may be updated and retrained to improve their accuracy or other performance target. The management system may create a ‘pipeline’ of classification engines that may grow to achieve a desired performance metric.

Many different machine classification systems may exist, from very lightweight systems that consume a small amount of resources, to larger, more complex classification systems that may be more accurate but more costly. By arranging the classification systems in a pipeline or hierarchy, the ‘better’ systems may be used to train and retrain the lightweight systems to improve their accuracy or other performance metric. Over time, the lightweight systems may asymptotically improve to the performance of the ‘better’system.

Many management systems may incorporate human in the loop at various points. Some systems may use humans for classification during the initial phases of starting a classification process, and as the classifiers improve, the human classification may be less and less frequent.

A script-like definition may be used to define the classification systems and their priority stack for a management system. Many such definitions may include expected or assigned parameters that may be used by the management system to set up and configure a classification pipeline. The parameters may include target performance metrics, which may be accuracy, latency, energy efficiency, or other target metric.

The script-like definition may further include the type of classification and, more specifically, the question the pipeline may be tasked with answering. For example, a classification pipeline may be created to monitor a security camera that monitors a dumpster in the back alley of a building. The query may be “Is the dumpster overflowing?” The definition may include images of the dumpster in an overflowing state, as well as images with the dumpster in a normal state.

The images defined in the script may be used as training data. In some cases, the script may reference pre-classified images that may be stored in a database, accessed through a Uniform Resource Locator (URL), or may use any other mechanism to reference the training data. Some classification projects may have tens, hundreds, thousands, or even millions or more images for classification.

The sequence of classifiers may indicate the classifier's priority, with some scripts defining the lightweight, lowest ‘cost’ classifiers first, and more expensive and presumably more accurate classifiers later in the sequence. Other systems may define a priority in reverse order. The sequence of classifiers may define the sequence in which one classifier may be checked by another classifier.

In general, the pipeline may attempt to monitor one classifier by using a sequence of other, more accurate classifiers to check the previous classifier. When the two classifiers do not agree, the output of the more trusted or higher cost classifier may be used to create a dataset to retrain the lower level classifier. The constant analysis and retraining of the lower cost classifier with a higher cost classifier should, over time, produce a more accurate version of the lower cost classifier. As the lower cost classifier improves, the higher cost classifier may be changed to monitor or sample the output of the lower cost classifier.

Some classifier pipelines may include three, four, or more classifiers in a hierarchy. Initially, all the classifiers may be trained on the same data, and all may analyze the same input stream. In theory, the classifiers on the higher end of the pipeline may coalesce earlier, as it would be expected that lighter weight classifiers may be less accurate. As the higher end classifiers start to achieve similar results, the highest-end classifier may be dropped from the pipeline or moved to a periodic monitoring state. Over time, the lower level classifiers may become increasingly accurate, aided by the higher-cost classifiers in the pipeline. As this happens, the higher-cost classifiers may be dropped or moved to a periodic monitoring state.

In some cases, the target accuracy or other performance metric may not be achievable by the lightest weight classifier. Even though the pipeline may grow and improve, the lightest weight classifier may not achieve the target. In such a case, the pipeline may coalesce where two or more classifiers are used to achieve the performance goal.

Different mechanisms may be used to compare results from one classifier to the next. For example, one mechanism may compare the output of a first classifier to a second classifier, and if the two classifiers match, the sequence ends.

Some cases may use a second, more “expensive” or more accurate classifier to validate the performance of a first, lower cost classifier. Over time, such a configuration may use the second classifier to audit the output of the first classifier.

Another use case may have the first classifier include a confidence parameter with the classification results. The confidence parameter may indicate how accurate the results may be. When the confidence parameter may indicate a strong confidence in the result, the result may be used as is. When the confidence parameter may indicate low confidence in the result, a second, more accurate classifier may be used to validate the result of the first classifier. Such a system may escalate multiple times, depending on the available classifiers in the system.

The classifier management system and classifier pipelines may be described in the context of image analysis as examples in this specification.

However, any type of machine-enabled classifier may benefit from the classifier management system, including large language models, speech to text engines, text to speech engines, text classification systems, chemical structure and graph-based classifiers, or any conceivable machine classification system.

### Improvements to Computing Architecture and Performance

The classifier management system may dramatically improve the performance of existing computing architectures by using one machine learning system to improve the quality of another machine learning system. The system automatically generates training data that may be identified and tagged by a more sophisticated classifier to retrain a lighter weight classifier. Such performance improvements may not have been possible without the pipeline of machine learning classifiers operating together.

The systems described herein are also of such complexity and handle such high volume of data that it would be impossible to replicate using manual methods. Many image classification systems operate using high resolution video, which generates millions of images per day. It is impossible for human operators to analyze, isolate, classify, tag, and manually retrain a classification system without the automation provided by a computer. As such, the automated computerized systems described herein must be considered outside the scope of ordinary human activity.

FIG. 1 is an illustration of an example 100 showing a classification management system that has several classifiers. A camera 102 may capture a scene 104, which may be an input sent to classifiers 108, 110, 112, and a human operator 114. The classifiers may be arranged with a set of comparators, which may be operations that compare the output of one classifier with the output of another classifier.

The classifiers may be arranged in a sequence based on accuracy, cost, or other performance metrics. In a typical example, the first classifier may be a low cost, lightweight classifier that may have relatively poor accuracy. By testing the first classifier against a higher cost, but presumably higher accuracy classifier, a comparator may identify when the lower cost classifier may fail to properly identify an image. The comparator may generate retraining data which may improve the lower cost classifier, so that over time, the higher cost classifier may automatically improve the lower cost classifier.

The concept of using a higher cost classifier to monitor and train a lower cost classifier may be expanded such that several classifiers may be arranged in a sequence, with each classifier monitoring and retraining the classifier below it.

Ideally, the lightest weight classifier may improve over time, such that the more expensive classifiers may be dropped from the sequence or used for periodic monitoring.

In the example 100, the classifiers may be arranged in a sequence from classifier 108, 110, 112, and finally, a human 114. The human 114 may be considered a high cost yet highly accurate classifier. In a typical use case, a human may be presented with an image that may have been classified by classifier 112, and the human 114 may determine if the classification may be correct.

Between each classifier 108, 110, 112, and human 114, a comparator 116, 120, and 124 may exist. The comparators may compare the classification results from one classifier with the results from a second classifier. In general, the classifiers may be arranged such that a more expensive yet more accurate classifier may check the results of a lower cost, lower accuracy classifier. When the two classifiers may differ, the comparator may generate retraining data 118, 122, and 126, which may be used to periodically retrain the lower cost classifiers.

Initially, all the classifiers 108, 110, and 112 may be trained using an initial set of training data 128. Once trained and in operation, the higher cost classifiers, which may include the human 114, may create retraining data that may improve the accuracy of the lower cost classifiers. Over time, the accuracy of the lower cost classifiers may approach a desired accuracy level.

The arrangement of example 100 may be a mechanism by which light weight classifiers may be trained to have any desired accuracy. With any machine-learning-based classifier, the accuracy of a classifier may be based on the available training data. When deploying a new classifier, the training data may not be readily available or may be unknown. By using two, three, or more classifiers together, the more accurate classifiers may be used to automatically retrain the previously less accurate classifiers to achieve the same or similar accuracy of the more expensive classifiers.

When initially deployed, the training data 128 may be relatively thin, as a user may have limited time or ability to meticulously generate a comprehensive training data set. By using the arrangement of example 100, more expensive classifiers may be used to generate a comprehensive training data set by operating the comparators and continually generating retraining data. Such a system may generate an extraordinarily dense and complete training data set that, when applied to even a lightweight classifier, may yield very high accuracy results. Such systems may take a period of time to converge on a desired accuracy, however, a classification system may be deployed quickly and grow to achieve the desired accuracy.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

The system 202 may have an administrative manager 222 through which a user may create, modify, and monitor a classification system using several classifiers. A user interface 224 may be a web page or other user interface through which an administrator may control, manage, and monitor operations of the classifiers.

Some systems may use a script-like definition to begin a classification project. The definition may include the goals of the classifier, including definitions of each classification to be made, the desired accuracy, available training data, and other information. The definition may also include a sequence of classifiers arranged from lighter-weight to more expensive classifiers. The sequence may define which classifiers are to be used to monitor, correct, and generate retraining data for another classifier. In many situations, two, three, four, or more classifiers may be arranged in such a fashion. In other systems, such information may be input into administrative manager 222 using an interactive user interface or other mechanism.

A set of training data 224 may be used by a training engine 226 to train one or more classifiers 228. The training data 224 may begin with a small set of images or other training data used to train a classifier. As the comparators 230 may begin comparing results between classifiers 228 and generating more retraining data, the training data 224 may become more populated.

The comparators 230 may be arranged to compare the results from one classifier with the results from another classifier. When the results differ, the results of a higher-ranked or more accurate classifier may be assumed to be ‘correct’. In such a situation, various statistics may be captured about the classifiers, but also the comparator may generate tagged training data that may be used to retrain the lower-ranked or less accurate classifier.

An execution engine 232 may arrange the classifiers and comparators, then may manage the classifiers and comparators as the classification system is deployed and executes. The execution engine 232 may control and monitor classifiers 228 and comparators 230, which may operate on the system 202, or may control and monitor classifiers and comparators that may operate on other hardware platforms. In many cases, machine learning-based classifiers may operate in cloud-based platforms, and the execution engine 232 may arrange such systems together to operate a comprehensive, unified classification system.

A network 234 may link various devices together.

A camera 236 may provide images that may be classified by the system 202 and other devices. The camera 236 may provide live stream of video, or may generate still images. Some systems may generate still images when something in the field of view changes, such as when a movement detector triggers the camera. Other systems may generate a continuous, live video feed, depending on the application.

A set of classifiers 238 may operate on a hardware platform 240 and may operate software components that may make up a classifier 242. In many cases, one, two, or several classifiers 238 may be linked together to receive the output from the camera 236 and perform classification. In a prototypical use case, a lightweight classifier may be physically located near the camera 236, while other, more expensive classifiers 238 may be located in various cloud environments. Because the system may use classifiers 238 from any location, many different classifiers may be accessed no matter where the physical location.

Similarly, a set of comparators 244 may operate on a hardware platform 246 and may operate software components that make up a comparator 248. The comparators 244, like the classifiers 238, may be physically located on any type of hardware platform, including remotely-located cloud-based systems, as well as locally operating systems, and any combination of the above.

A user device 250 may operate on a hardware platform 252 and may present various user interfaces 256 and administrative interfaces 258 in a browser 254. The device 250 may be one example of a device through which a user may access the system.

An administrative interface 258 may allow a user to create a new classification project combining multiple classifiers, construct the architecture of the classification system, upload or generate at least some training data, and begin to deploy the classification system. The administrative interface 258 may also be used to monitor the performance of the system, make changes to the classifiers and comparators within the system, and perform other administrative tasks.

The user interface 256 may include a mechanism by which a human operator may evaluate the results of a classifier. In a typical use case, the user interface may present an image and a classification result. The user may confirm the result or indicate that the result is incorrect. The user may be able to identify the correct classification. When such a correction occurs, a set of retraining data may be captured and subsequently used to retrain the classifier.

FIG. 3 is an example 300 showing a classifier definition script. The example 300 is merely one mechanism and format for defining a classification project that uses multiple classifiers.

A set of classification parameters 302 may define the name of the classification system, the modality (in this case, a binary classification is used), and the basic query (in this case, “is the dumpster overflowing?”). The classification parameters may include text-based descriptors and links to training data 312 and 314.

The classification parameters 302 may include accuracy parameters 316. The accuracy parameters 316 may define the desired or target accuracy of the system. As the training data grows and is improved by the various classifiers, the overall accuracy of the system may asymptotically approach the desired accuracy.

The desired accuracy may also be used to reduce and eventually eliminate the use of more expensive classifiers as the lower cost classifiers improve their accuracy.

A sequence of classifier models 304, 306, 308, and 310 may be defined for the project. Within each classifier model, the type of classifier may be included, along with various expected parameters. In the example, parameters such as cost, expected latency, expected accuracy, and other parameters may be included. In some cases, such parameters may be used to set up and configure the respective classifier by passing the parameters to the classifier. In other cases, the parameters may be used by comparators and execution engines to determine when to increase or decrease the use of more expensive classifiers as the system performs.

FIG. 4 is an example 400 showing a script-like definition of an overall classification system.

An image source definition 402 may define the source of the images, including a Uniform Resource Locator (URL) for the camera output, as well as various parameters defining the camera behavior, name, and formatting.

A detector definition 404 may include or reference a classification script, such as what was shown in example 300.

A processor definition 406 may define the name of the classification system, as well as other parameters used to configure and manage the system.

A trigger/alarm definition 408 may define the triggers and actions to be taken when a trigger may be generated. The action definition 410 may define the specific actions to be taken. In the example 400, the triggers may result in an SMS message to be sent to a specific phone number with a message “The dumpster is overflowing!”

FIG. 5 is a flowchart illustration of an example 500 showing a method for configuring and operating a classification system made up of multiple classifiers. The operations of example 500 show one workflow of how a series of classifiers may be configured, linked together using comparators, trained, and deployed.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Example 500 illustrates how various classifiers may be configured in a sequence or priority, such that lighter weight, lower-level classifiers may be compared with more expensive and presumably more accurate classifiers. When differences between the lower level classifiers and the higher level classifiers exist, a retraining dataset may be created and used to retrain the lower level classifier. Such a system may continually create retraining data which may improve the lower level classifier to approach the accuracy of more expensive classifiers.

A configuration may be received in block 502. The configuration may be defined using a configuration file or script, as illustrated in examples 300 and 400. However, some systems may use other mechanisms, such as an interactive user interface, to define, configure, and link the various classifiers.

An initial set of training data may be received in block 504.

Using a sequence of classifiers received in block 506, a baseline classifier may be configured in block 508 to receive and process an image source. The baseline classifier may be the lightest weight, lowest cost classifier.

In many systems, the lightest weight classifier may be the target classifier for a particular application. Such a classifier may not have sufficient training data or initial capacity or accuracy to perform a desired function. By using more expensive and elaborate classifiers to generate retraining data, the lighter weight classifier may be trained by the more expensive classifiers until the lighter weight classifier meets or exceeds a desired accuracy level.

Systems that may use two, three, or more classifiers may take advantage of each classifier's strengths to catch inconsistent or inaccurate classifications. The inaccurate classifications may then be fed back to less capable classifiers to improve those classifier's accuracy.

For each subsequent classifier in block 510, the classifier may be configured to receive input in block 512. A comparator process may be configured in block 514 to compare the output from the current classifier with the output from the previous classifier.

The comparator may be further configured in bloc 516 to generate retraining data based on discrepancies between the classifiers, and the previous classifier may be configured to receive the retraining data and be retrained in block 518.

For each classifier in block 520, the classifier may be trained using the initial training data in block 522.

An execution engine may be configured in block 524 to manage the classifiers and pipeline of communications between the classifiers, comparators, and other components of the system, after which, the classification system may be deployed in block 526.

FIG. 6 is a flowchart illustration of an example 600 showing a method for deployment and operation of a classifier system using multiple classifiers. The operations of example 600 show one workflow of how a classification system may be deployed using a group of pre-configured classification systems. Once deployed, a classifier may be further trained for a specific use case.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The system may begin operation in block 602 to set up and operate a classification system. A set of input images may be received in block 604, and an initial classification may be made with a lowest ‘cost’ classifier in block 606.

For each successive classifier in block 608, a classification may be performed in block 610. If the next classifier produces the same results as the previous classifier in block 612, the performance may be tracked in block 614 and the loop may be exited in block 616.

If the current classifier does not yield the same results as the previous classifier in block 612, the loop may advance to the next higher classifier in the sequence in block 618, and training data for the lower level classifier may be generated in block 620.

The loop of block 608 may be designed to go through a sequence of increasingly accurate classifiers and ensure that a first classification by one of the classifiers may be confirmed by another, higher level classifier. When a discrepancy may be encountered, the sequence may advance to yet another higher level classifier to verify or validate the results. In some cases, a higher level classifier may be a machine-operated automatic classifier, while in other cases, a human operator may serve as a classifier.

The loop of block 608 may be an example of an operational pipeline that exits the loop once two different classifiers agree with the same result. Other pipelines may be constructed to continue classifying and comparing results between classifiers such that every input image may be classified and the results compared.

Such other pipelines may be used during the initial setup and operation of a classification system, but as two classifiers repeatedly agree, the pipelines may adjust the frequency of checking lower level classifiers with higher level classifiers to a periodic or sampling basis.

For each classifier in block 622, if new training data are available in block 624, the classifier may be retrained in block 626. The retraining loop of block 622 may be performed each time new training data may be available, but in alternative uses, the training data may be aggregated together and retraining may happen at some point in the future. Some systems, for example, may be configured to automatically retrain a classifier on a set period, such as every hour, every day, or some other period.

For each classifier in block 628, the accuracy of a given classifier may be compared to the accuracy of the next-higher classifier in block 630. Some systems may compare the accuracy of a given classifier to all higher level classifiers or two or more classifiers. If a desired accuracy goal has been achieved in block 632, the use of the higher level classifiers may be changed to a periodic audit basis in block 634. In some cases, the periodic audit may be reduced or eliminated.

The loop of block 628 may represent one mechanism by which the complexity and cost of operating multiple classifiers may be reduced or even eliminated as the lowest cost, lightest-weight classifier becomes increasingly accurate. The training data provided by the more costly and, initially, more accurate classifiers may enhance the accuracy of the lighter-weight classifier, thereby resulting in a fully trained, accurate classifier that is, eventually, lighter weight and less costly than could be achieved with an initial training data set.

FIG. 7 is a flowchart illustration of an example 700 showing a method for deployment and operation of a classifier system using multiple classifiers where the classifiers output a confidence parameter. The operations of example 700 show one workflow of how a classification system may be deployed using a group of pre-configured classification systems. Once deployed, a classifier may be further trained for a specific use case.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Operation may begin in block 702. An item for classification may be received in block 704, and the item may be classified in block 706.

The classifier may output the classification results in block 708, including a confidence parameter. The confidence parameter may indicate how reliable the results may be. In many cases, the confidence parameter may be mathematically calculated to represent the strength of matching the input to the training data. While different classifiers may have different underlying matching or classification algorithms, many such classifiers may calculate a parameter or set of parameters that may represent the degree to which a classification may be made.

The confidence parameter may be compared in block 710 against a threshold to determine whether the confidence parameter may be strong enough for the specific application.

When the confidence parameter may not be strong enough in block 710, and there is a higher quality classifier available in block 712, the classification may be performed in block 714 using the higher quality classifier. The result of the second classifier may be stored in block 716 for later retraining of an earlier classifier.

The process may return to block 708, where the classification result and the confidence parameter may be received. The process may cycle through several different classifiers when the confidence parameter of each classifier may not reach the threshold defined in block 710.

When no more classifiers are available in block 712 or when the confidence parameter exceeds the threshold in block 710, the results may be returned to the requester.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A system comprising:
at least one processor configured to perform a method comprising:
receiving a set of inputs, said set of inputs comprising identifications of a plurality of machine learning systems comprising a first machine learning system and a second machine learning system;
configuring a first machine learning system and a second machine learning system to receive a first set of training data;
causing said first machine learning systems and said second machine learning system to be trained on said first set of training data;
configuring an analysis system to measure results from said first machine learning system and said second machine learning system;
deploying said first machine learning system and said second machine learning system to receive a first input stream and to generate a first output stream from said first machine learning system and a second output stream from said second machine learning system; and
when said first output stream does not agree with said second output stream, create a second set of training data and causing said first machine learning system to be re-trained on said second set of training data.

2. The system of claim 1, said set of inputs further comprising a human verification system, said method further comprising:
configuring said human verification system to receive at least a portion of said first input stream;
comparing output from said human verification system and said second output stream to identify at least one disparity between said output from said human verification system and said second output stream;
creating a third set of training data comprising said at least one disparity and re-training said second machine learning system with said third set of training data.

3. The system of claim 1, said set of inputs further comprising a set of objectives, said set of objectives comprising an accuracy factor, said method further comprising:
comparing said first output stream and said second output stream to determine that said first machine learning system meets said accuracy factor; and
stopping said second machine learning system from receiving said first input stream.

4. The system of claim 1, said set of inputs further comprising a set of objectives, said set of objectives comprising an accuracy factor, said method further comprising:
comparing said first output stream and said second output stream to determine that said first machine learning system meets said accuracy factor; and
configuring said second machine learning system to receive a portion of said first input stream, said portion being less than 100%.

5. The system of claim 4, said portion being less than 10%.

6. The system of claim 4, said method further comprising:
while receiving a portion of said first input stream by said second machine learning system, comparing said first output stream and said second output stream and determining that said first output stream is lower than said accuracy factor, adjusting said second machine learning system to receive a full portion of said first input stream.

7. The system of claim 4, said method further comprising:
while receiving a portion of said first input stream by said second machine learning system, comparing said first output stream and said second output stream and determining that said first output stream is lower than said accuracy factor, adjusting said second machine learning system to receive a higher portion of said first input stream.

8. The system of claim 1, said set of inputs comprising a cost for each of said plurality of machine learning systems, said first machine learning system having a lower cost than said second machine learning system.

9. The system of claim 8, said cost comprising a factor for processing cost.

10. The system of claim 1 said first output stream comprising a confidence factor, said method further comprising:
when said confidence factor is below a predetermined threshold, causing said second machine learning system to receive said first input stream.

11. A method performed at least in part using a computer processor, said method comprising:
receiving a set of inputs, said set of inputs comprising identifications of a plurality of machine learning systems comprising a first machine learning system and a second machine learning system;
configuring a first machine learning system and a second machine learning system to receive a first set of training data;
causing said first machine learning systems and said second machine learning system to be trained on said first set of training data;
configuring an analysis system to measure results from said first machine learning system and said second machine learning system;
deploying said first machine learning system and said second machine learning system to receive a first input stream and to generate a first output stream from said first machine learning system and a second output stream from said second machine learning system; and
when said first output stream does not agree with said second output stream, create a second set of training data and causing said first machine learning system to be re-trained on said second set of training data.

12. The method of claim 11, said set of inputs further comprising a human verification system, said method further comprising:
configuring said human verification system to receive at least a portion of said first input stream;
comparing output from said human verification system and said second output stream to identify at least one disparity between said output from said human verification system and said second output stream;
creating a third set of training data comprising said at least one disparity and re-training said second machine learning system with said third set of training data.

13. The method of claim 11, said set of inputs further comprising a set of objectives, said set of objectives comprising an accuracy factor, said method further comprising:
comparing said first output stream and said second output stream to determine that said first machine learning system meets said accuracy factor; and
stopping said second machine learning system from receiving said first input stream.

14. The method of claim 11, said set of inputs further comprising a set of objectives, said set of objectives comprising an accuracy factor, said method further comprising:
comparing said first output stream and said second output stream to determine that said first machine learning system meets said accuracy factor; and
configuring said second machine learning system to receive a portion of said first input stream, said portion being less than 100%.

15. The method of claim 14, said portion being less than 10%.

16. The method of claim 14, said method further comprising:
while receiving a portion of said first input stream by said second machine learning system, comparing said first output stream and said second output stream and determining that said first output stream is lower than said accuracy factor, adjusting said second machine learning system to receive a full portion of said first input stream.

17. The method of claim 14, said method further comprising:
while receiving a portion of said first input stream by said second machine learning system, comparing said first output stream and said second output stream and determining that said first output stream is lower than said accuracy factor, adjusting said second machine learning system to receive a higher portion of said first input stream.

18. The method of claim 11, said set of inputs comprising a cost for each of said plurality of machine learning systems, said first machine learning system having a lower cost than said second machine learning system.

19. The method of claim 18, said cost comprising a factor for processing cost.

20. The method of claim 18, said first output stream comprising a confidence factor, said method further comprising:
when said confidence factor is below a predetermined threshold, causing said second machine learning system to receive said first input stream.
